(19) United States
(12) Patent Application Publication
(10) Pub. No.: US 2006/0069781 A1
(43) Pub. Date: Mar. 30, 2006

(54) Global internet voice communication system method

(76) Inventors: Erh-Jen Hou, Taipei (TW); Chun-Wei Lien, Taipei (TW); Guan-Hung Yeh, Taipei (TW); Er-Ta Ma, Taipei (TW); Ming-Shun Hsiao, Taipei (TW); Wen-Cheng Liu, Taipei (TW)

Correspondence Address: PRO-TECHTOR INTERNATIONAL SERVICES, 20775 Norada Court, Saratoga, CA, 95070-3018, US

(21) Appl. No.: 10/937,231

(22) Filed: Sep. 8, 2004

(51) Int. Cl. G06F 15/16

(52) U.S. Cl. 709/227

(57) ABSTRACT

A global communication internet telephone system and method is a new software Web Call structure, wherein the system user only requires a computer with Windows 98 or above, a duplex sound card, a display interface and internet access, and logging directly into a GTD Web 800 wed page thereafter, receiving a automatic number dispensing function and GTD automatic number skipping function.

### BACKGROUND OF THE INVENTION

(a) Field of the Invention

The present invention relates to an internet voice communication carrier system used by computer web pages. The system includes web page login, automatic number appointing and number skipping functions. Since no complex hardware is needed for installation, only appointing a number dispensing interval, a number for automatic skipping and an address of the website containing the GTD is needed, the components and the corresponding web pages expressing language documents are put together thereafter.

(b) Description of the Prior Art

With the development of the Internet, the Web Call system has also been renovated many times over. There are already internet phones on the market, but due to the difficulty in system installations and high capitals, the mobility of usage by system users are not high, therefore the internet phone has never widespread.

### SUMMARY OF THE INVENTION

It is a primary objective of the present invention to provide a user with only a computer that has an operating system of Windows 98 or above (including MS Internet Explorer), a duplex sound card, a display interface and Internet access, to enable the user directly logging into Web Call 800 web page and receiving an automatic number dispenser function and a GTD number skipping function. Since no complex hardware is needed for installation, only appointing a number dispensing interval, a number for automatic skipping and an address of the website containing the GTD is needed, the components and the corresponding web pages expressing language documents are put together thereafter.

The aforesaid Web Call structure is commonly known as GTD (Global Telephone Directly). GTD is a component of Active X on a web page, used for Internet voice communication.

To enable a further understanding of the said objectives and the technological methods of the invention herein, the brief description of the drawings below is followed by the detailed description of the preferred embodiments.

### BRIEF DESCRIPTION OF THE DRAWING

FIG. 1 shows a structural block diagram according to the present invention.

FIG. 2 shows a flow chart block diagram according to the present invention.

### DETAILED DESCRIPTION OF THE PREFERRED EMBODIMENTS

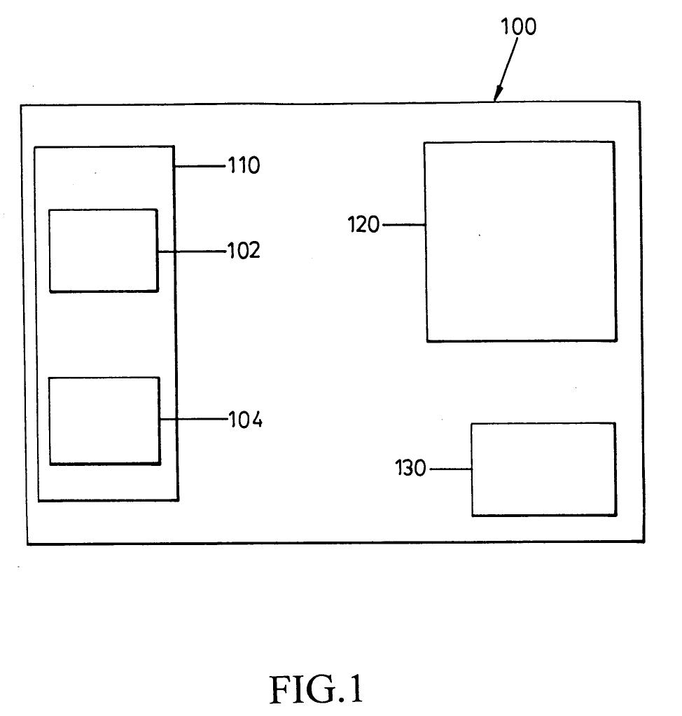

As shown in FIG. 1, a system 100 consists of a computer unit 110, a website 120 having GTD component and a user computer 130 that is logged into a GTD appointed taxi internet communication system, in addition, a computer with an operating system of windows 98 or above, a duplex sound card 102, a display interface 104 and Internet access is required.

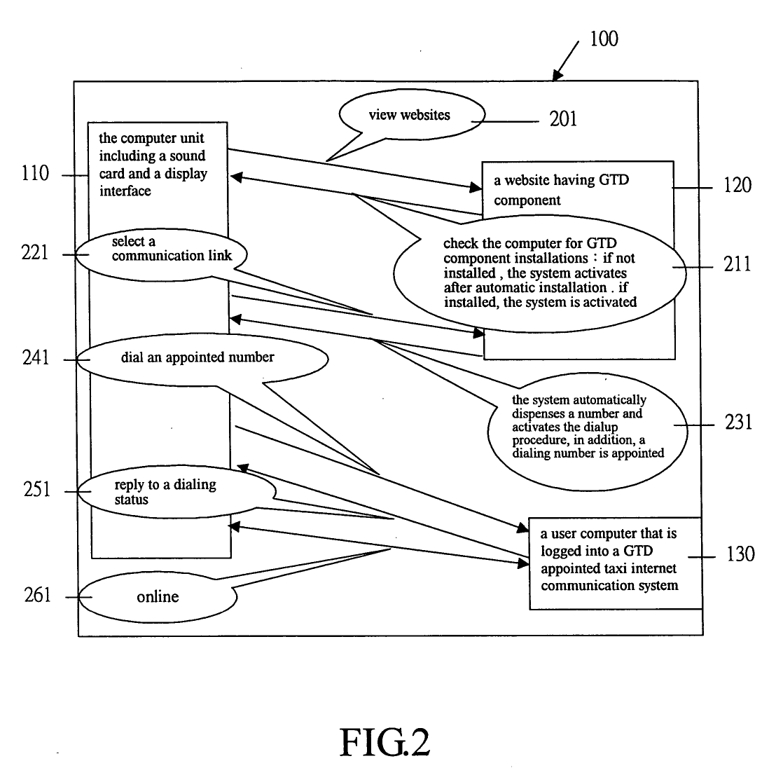

The flow chart diagram of the GTD system as shown in FIG. 2 comprises:
1. A user views websites with GTD components 201 by using the computer unit 110 including a sound card and a display interface.
2. Checking the computer 110 for GTD component 211 installations

(1) If GTD components are not installed, the system 100 activates after automatic installation.

(2) The system is activated if GTD components are installed.
3. User can select a communication link 221 from the GTD component web page 120.
4. The system 100 automatically dispenses a number and activates the dialup procedure, in addition, a dialing number 231 is appointed thereafter.
5. The user then dials an appointed number 241.
6. The user's computer is then logged into a GTD appointed TAXI internet telephone system 130 and replies to a dialing status.
7. Online 261.

The aforesaid invention has three main functions:

(1) Direct login into GTD WEB 800 website:
The user only needs a computer unit that has an operating system of Windows 98 or above (including MS Internet Explorer), a duplex sound card, a display interface and Internet access. The web call communication function is activated through the application of MS Internet Explorer software.

(2) Automatic appointment of number to a user
When the user selects a button on the GTD website, the system automatically and systematically appoints a communication group. If the next user is offline or busy, the system automatically skips to the next appointed verified number.

(3) Automatic number skipping:
When the user selects a button on the GTD website, a communication group is automatically and systematically dialed up by the system. If the next user is offline or busy, the system automatically skips to the next appointed verified number.

In conclusion, the aforesaid system entirely corrects the deficiency of Web Call, in addition, the provided GTD has login, automatic number appointing and automatic number skipping capabilities. Since no complex hardware is needed for installation, only appointing a number dispensing interval, a number for automatic skipping and an address of the website containing the GTD is needed, moreover, the components are put together to achieve the aforesaid functions.

It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. A global communication internet telephone system and method namely GTD (Global Telephone Directory) within the Web Call structure, wherein GTD is a component of Active X in a web page applied for internet voice communication, comprising steps of;
(1) a computer, using Windows 98 or above, including a duplex sound card, a display interface and internet access;
(2) a web page with GTD components, connecting to the computer for viewing web pages, checking for GTD components and automatic dispensing of number, activating dialup procedure and appointing dialup number;
(3) a user computer already logged into the GTD appointed TAXI internet telephone system, connecting to the computer to begin dialing of appointed number, receiving dialing status and connecting online.

2. The global communication internet telephone system and method as recited in claim 1, wherein a computer with an operating system of Windows 98 or above including MS Internet Explorer is used.

3. The global communication internet telephone system and method as recited in claim 1, wherein no complex hardware is needed for installation, only appointing a number dispensing interval, a number for automatic skipping and an address of the website containing the GTD is needed, the components and the corresponding web pages expressing language documents are put together thereafter.
